(19) United States
(12) Patent Application Publication
(10) Pub. No.: US 2018/0059921 A1
(43) Pub. Date: Mar. 1, 2018

(54) CUSTOM GUI CONTROL FOR VISUALIZING FIELD DATA

(71) Applicant: Honeywell International Inc., Morris Plains, NJ (US)

(72) Inventor: RUUD DE LIGT, VLAARDINGEN (NL)

(21) Appl. No.: 15/254,839

(22) Filed: Sep. 1, 2016

(51) Int. Cl. G06F 3/0484; H04L 29/08; G06F 3/0482; G05B 19/418

(52) U.S. Cl. CPC G06F 3/04847; G05B 19/41835; G06F 3/0482; H04L 67/025

(57) ABSTRACT

A method of custom GUI control. Field data is sent to a data acquisition module coupled to a processing block that assembles a serialized object message (SOM) by a selected topic including data values, display sub-controls coupled to an IP data provider that stores the topics, an algorithm for publishing SOMs and a publisher/subscriber pattern including clients. The clients have a GUI application including a custom GUI control subscribed to the IP data provider. The IP data provider publishes SOMs by the selected topic as call-backs over an IP bus shared by the clients including to the first client including an initial SOM which generates the custom GUI control and stores the selected topic as a referable instance for populating GUI components and a subsequent SOM having an updated value, wherein the GUI application accesses the custom GUI control to populate the GUI components by only overwriting the changed values/parameters.

### FIELD

Disclosed embodiments relate to process data visualization for controlling an industrial process, particularly control for presenting field data in a graphical user interface (GUI).

### BACKGROUND

Process control systems for industrial processes, whether distributed control system (DCS) or supervisory control and data acquisition (SCADA) systems, generally include one or more process controllers communicatively coupled to at least one host (e.g., an operator workstation) and to one or more process control devices (e.g., field devices) configured to communicate via analog, digital or combined analog/digital communication signals and/or protocols. Such process control systems are commonly used in chemical, pharmaceutical, pulp and paper manufacturing and petroleum processes. The field devices can comprise device controllers, valves, valve actuators or positioners, switches, transmitters (e.g., temperature, pressure, flow rate, or chemical composition sensors), performing functions within the process control system such as opening and/or closing valves and measuring process parameters. The process controller receives signals indicative of process measurements made by the field devices and/or other information pertaining to the field devices, uses this information to implement a control routine, and generates control signals over buses and/or other communication lines to the field devices to control the operation of the process control system.

Some industrial processes such as petroleum refining include storage tanks. Tank gauging is needed for the assessment of tank contents, tank inventory control and tank farm management. Radar and servo tank sensors (or gauges) help in accurate level gauging for refineries, tank terminals and petrochemical industries. Tank inventory systems utilize tank gauging data and provide connectivity for various field protocols that enable integration of existing field equipment. A set of standardized host interface areas are available to link software packages to control systems and business domain packages for advanced resource planning and asset management.

There are known tank inventory systems sufficiently flexible to handle tank farms ranging from a single tank up to more than 250 tanks, covering multiple locations and a variety of different gauges and interfaces. One such conventional tank inventory system comprises a pair of embedded software applications running in a Communication Interface Unit (CIU) that is essentially basically an embedded personal computer (PC) and a dedicated WINDOWS GUI application that provides GUIs in standard formats for representing process data with both text and graphics running on the PC at an operator station or at a distributed control system (DCS).

In tank gauging all measured, calculated and configured field (or process) data is generally expected to be shown in GUI components (e.g., textboxes, labels) of one or more GUIs of display device for an operator along with the accompanying status and validity (SV) of the parameter's value. For example, the SV of a temperature with the value 0 degrees C. should indicate whether the zero value is measured or it is zero since the value is not measured yet. The SV is known to be important for weights and measures. Typically a measured value gets bound to a textbox or label in a GUI of a display and a next label at a subsequent time is then used to display the validity for the measured value in the GUI.

FIG. 1 depicts conventional GUI control visualization of field data for process control in an industrial control system 100. The field data from the field devices 110 (sensors 110a, 110b, and actuator(s) 110c, collectively field devices 110) coupled to processing equipment 112a, 112b in the plant 105 gets acquired by the GUI application layer (GUI application) 152 of an application layer 150 via a field layer 130 comprising a data acquisition module 135a (e.g., a CIU functioning as a scanner) through a value cache 135b by a Modbus block 135c over a Modbus connection 139 to the GUI application 152. Processing features for the application layer 150 and field layer 130 are shown implemented by a processor 160 running algorithms 161 stored in a memory 160. Although the application layer 150 and field layer 130 are shown in FIG. 1 implemented by a single processor 160 having associated memory 161, it is understood in a typical arrangement the application layer 150 and field layer 130 will be hosted at different locations. Accordingly, the application layer 150 and field layer 130 will each generally have its own processor and associated memory.

The GUI application 152 includes a physical display having at least one display element 152a₁ comprising a plurality of GUI components 152a₂ including a value component, and software comprising a business layer 152b, and a GUI control layer 152c. The GUI control layer 152c comprises format/status 156, format/conversions control 154 and dimension control 155. The raw field data gets extracted by extraction block 153 via the polling data block 157, and is formatted and/or converted by format/conversions control 154 of the GUI control layer 152c. Format/conversions control 154 controls the value GUI component, dimension control 155 controls the dimension GUI component, and format/status control 156 controls the format/status GUI component. Format/conversions control 154, dimension control 155 and format/status control 156 can each be considered sub-controls (i.e., software methods) that each provide display attributes of the GUI components 152a₂.

The configuration database 151 shows the business layer 152b and the GUI control layer 152c what units of measurement to display in the display element 152a₁, and parses the status and validity to show the GUI application 152 has multiple GUI sub-controls to handle a variety of special processing. Each new acquired field data value is forwarded to the extraction block 153 to enable finally updating the value component of the GUI components 152a₂ with a new data value.

The sub-controls (format/conversions control 154, dimension control 155 and format/status control 156) of the GUI control layer 152c are individually controlled by the business layer 152b. The display control information provided by the business layer 152b includes display attributes such as for the units of dimension, and the minimum and maximum allowed values for the parameter fetched by the GUI application 152 from the configuration database 151, and a timestamp generally gets added by the GUI application 152 upon arrival. The delivering and visualizing/display of each field data value from the modbus 135c to the GUI components 152a₂ of the display element 152a₁ thus requires several separate messages besides the message delivering the field data. The separate messages include a separate message from the format/conversions control 154 to the value component, a separate message from dimension control 155 to the dimension component, and a separate message from format/status control 156 to the status component.

### SUMMARY

This Summary is provided to introduce a brief selection of disclosed concepts in a simplified form that are further described below in the Detailed Description including the drawings provided. This Summary is not intended to limit the claimed subject matter's scope.

As described above, in known Graphical User Interface (GUI) control visualizing of process data for industrial process control, the delivering of the field data to the GUI application of an operator's display device requires several separate messages, with the field data value being in a separate message from the other messages delivering the necessary respective GUI display sub-controls (or control attributes) for displaying related information to the parameter corresponding to the data value such as its dimension and status. For displaying the various information related to the parameter being displayed, the GUI application collects all display control information from the various messages from the various different sub-controls to display the content shown in the GUI components of the display element on the display screen.

Disclosed GUI control visualizing of process data for industrial process control instead uses a generic control methodology utilizing a single published message that comprises a generic serialized object (e.g., JavaScript Object Notation (JSON), Binary JSON (BSON) or other serialized object type) that includes the data value, and all the display control attributes used for creating a custom GUI control at the GUI application. The custom GUI combined display control thus includes a plurality of sub-controls which can be collectively considered to be a GUI panel. The sub-controls show units of dimension and needed directions for the GUI application to display this information (e.g., update rate, priority) in one or more GUI components of a display element of display device. After the custom GUI control is created and configured from an initial serialized object message in the form of serialized object data, subsequent field data can be displayed by simply overwriting updating the changed values of the display element.

Disclosed embodiments recognize it is a major improvement to combine the field data (from a given time, and from a particular processing equipment) comprising a topic (e.g., tank1/level 1), field data value, and all the necessary sub-controls providing display attributes and display directions in a single serialized object type (e.g., (JSON)) message. By updating using a serialized object message the field data with its sub-controls the update is made atomically (i.e., not split into separate messages as in known methods). This is an advantage as it simplifies the business layer of the GUI application significantly (see business layer 252b in FIG. 2 described below). All messages can be handled the same way and all data (the value and its related information such as dimension and status) kept together.

After the initial message where the custom GUI control is created for a given topic, for displaying values regarding the topic the GUI application does not need to look-up things such as the units of dimensions for the parameter All sub-controls with their display attributes will be published in the serialized object message. Once received by the business layer and forwarded to the custom GUI control the custom GUI control will take care of displaying the data for the given topic in the GUI components of the display element generically. Disclosed embodiments instead of conventionally binding each respective sub-control to a data element in conventional GUI visualization of field data for industrial process control such as described below in FIG. 1 which requires multiple messages to display each field data value, use a single message in the form of serialized object (e.g., JSON object) which provides the data value and all of its sub-controls.

### BRIEF DESCRIPTION OF THE DRAWINGS

FIG. 1 depicts conventional GUI control layer for visualization of field data for process control in an industrial control system requiring multiple messages to display each data value.

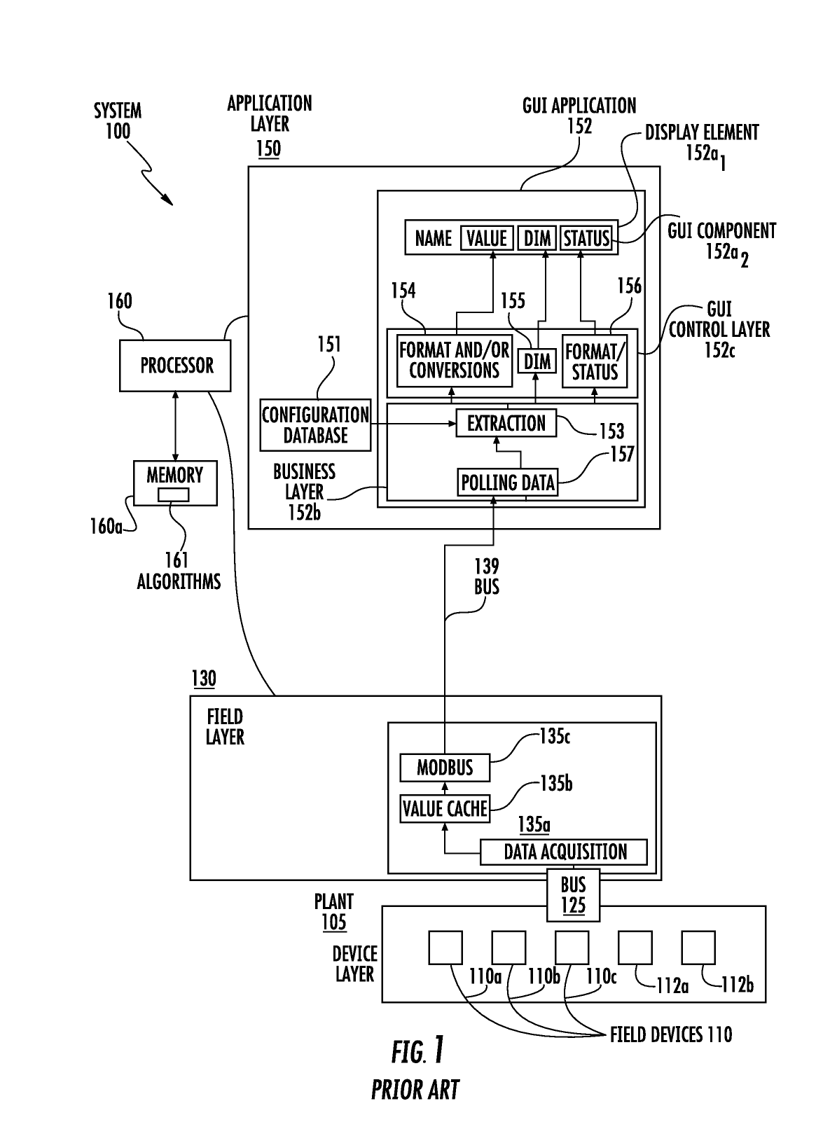

FIG. 2 depicts disclosed custom GUI control for visualization of field data for process control in an industrial control system that utilizes a single message in the form of a published serialized object per data value, according to an example embodiment.

FIG. 3 is a flow chart that shows steps in a method of visualizing of field data for process control in an industrial control system using a single message in the form of a published serialized object per data value, according to an example embodiment.

FIG. 4 shows example GUI components of a display of a PC controlled by a disclosed custom GUI control that receives the JSON message shown.

FIG. 5 is a scanned picture that shows the workings of a disclosed custom GUI control in a proof of concept (POC) created in an example display that includes the GUI components shown.

FIG. 6 is a scanned picture that shows example verbose information of all JSON fields including live updates shown when the user right clicks on the value textbox.

FIG. 7 is a scanned picture that shows example verbose information about the status and validity when the user right clicks on the place where the status is shown.

FIG. 8 is example context sensitive, detailed help about the entity of selected control that shows a hyperlink available to launch a help file (e.g. a Microsoft Compiled HTML file (chm-file)) which show all details and help for the data displayed by the GUI application.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

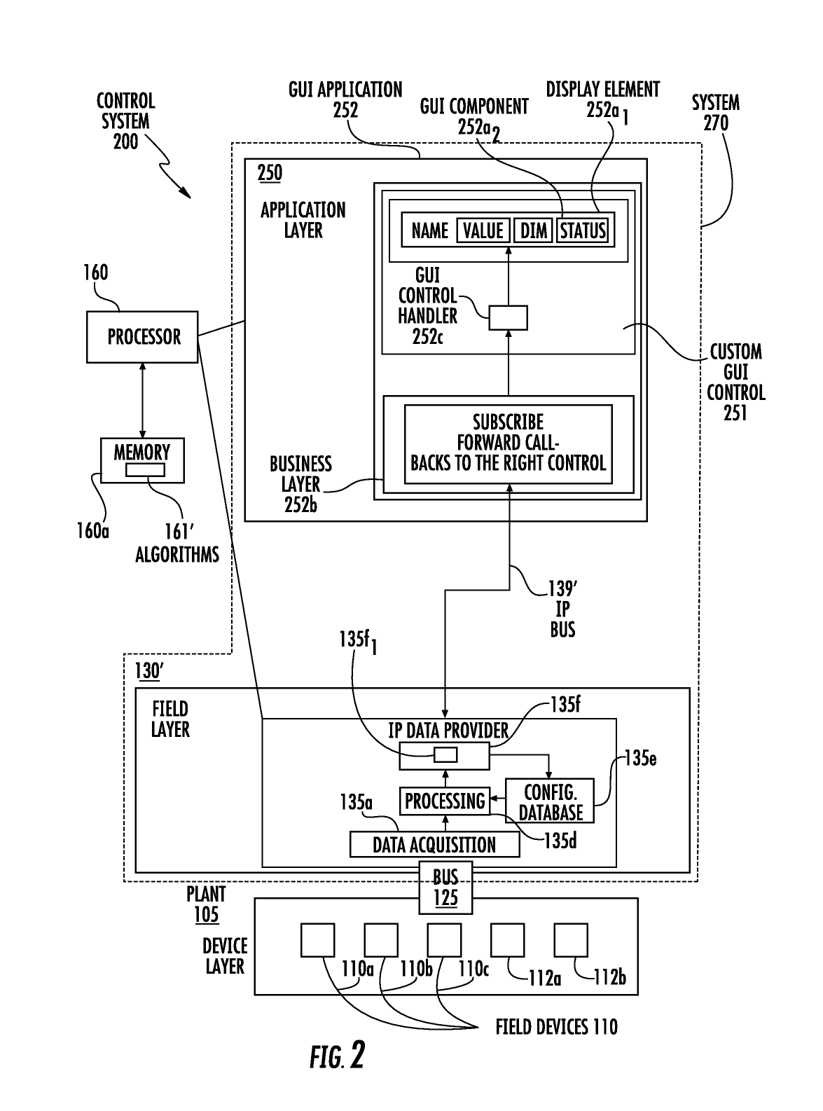

FIG. 2 depicts disclosed custom GUI control for visualization of field data for process control in an industrial control system 200 that has an application layer 250 including a GUI application 252 for displaying which utilizes a single message in the form of a published serialized object per data value, according to an example embodiment. The GUI application 252 includes a display including at least one display element 252a₁ that has at least one GUI component 252a₂ (e.g. fillable box with data, text or plots, context menu(s), pop-up with detailed information and optionally a send button), a business layer 252b, and a custom GUI control 251.

The field layer 130′ includes a data acquisition module 135a (e.g., a Communication Interface Unit (CIU)) that has a variety of information in its configuration database 135e generally supplied by a service tool application (not shown) in the application layer 250 sent to the IP data provider 135f. The field layer 130′ and application layer 250 are collectively shown as a data processing and visualization system 270 that has its processing features shown implemented by a processor 160 running algorithms 161′ stored in a memory 160. Although the application layer 250 and field layer 130′ are shown in FIG. 2 implemented by a single processor 160 having associated memory 161, it is understood in a typical arrangement the application layer 250 and field layer 130 will be hosted at different locations. Accordingly, the application layer 150 and field layer 130 will each generally have its own processor and associated memory. For example, when the IP bus 139′ is routed via the Internet, the respective application layer 250 and field layer 130 can be very far apart from one another, and will therefore each have its own processor and associated memory.

Data processing of field data from the field devices 110 over the bus 125 (e.g., Modbus) is performed by the data acquisition module 135a which functions as an interface unit and the processing block 135d assembles the pre-processed field data received from the data acquisition module 135a into a complete serialized object (e.g., JSON object). As known in the art, a JSON object is an unordered collection of name/value pairs in a string wrapped in curly braces with colons between the names and values, and commas between the values and names.

The serialized object message assembled by the processing block 135d includes a value of the measured field data by a topic from a plurality of topics stored in the memory 135f₁ of the IP data provider 135f. The topics function as an identifier, and the serialized object message is published by the processing block 135d as a payload to the IP data provider 135f (e.g., Message Queuing Telemetry Transport (MQTT) broker of an Open Process Control Unified Architecture (OPC UA) server). The IP data provider 135f publishes a new serialized message over the IP bus 139′ each time new field data arrives from the data acquisition module 135a and receives new configuration information over the IP bus 139′ when sent by the GUI application 252.

The memory 135f₁ also stores a publisher/subscriber pattern comprising a plurality of clients including at least a first client that each has a GUI application 252 including a display with at least one display element 252a₁ with at least one GUI component 252a₂ that is controlled by the custom GUI control handler 252c. The published messages from the IP data provider 135f are by a selected topic from the available plurality (tree) of topics for call-backs to the clients. The memory 135f₁ has a stored algorithm for transmitting the call-backs as a single serialized object message (temporary: e.g., JSON message) by the selected topic including the value, a, and display sub-controls over an IP bus 139′ shared by said plurality of clients. The topics function as addresses and can comprise a particular equipment or type of equipment and a parameter, such as tank1/level1.

By control system 200 using publish subscribe features of a modern Internet Protocol (IP) connectivity protocol (such as a machine-to-machine (M2M) protocol based on Internet of Things” (IIoT) technologies) because of their broader bandwidth as compared to serial remote terminal unit (RTU) lines (e.g., Modbus), the data gets delivered to the operator having the display element 252a1 with the GUI components 252a2 significantly faster. Other advantages include the IP communications simplifying configuration changes as they are published by the GUI application 252 back to the IP data provider 135f for storage in the configuration database 135e. The GUI application 252 can send back modified data regarding the custom GUI control 251, e.g. configuration changes or manual overwrites of measured data.

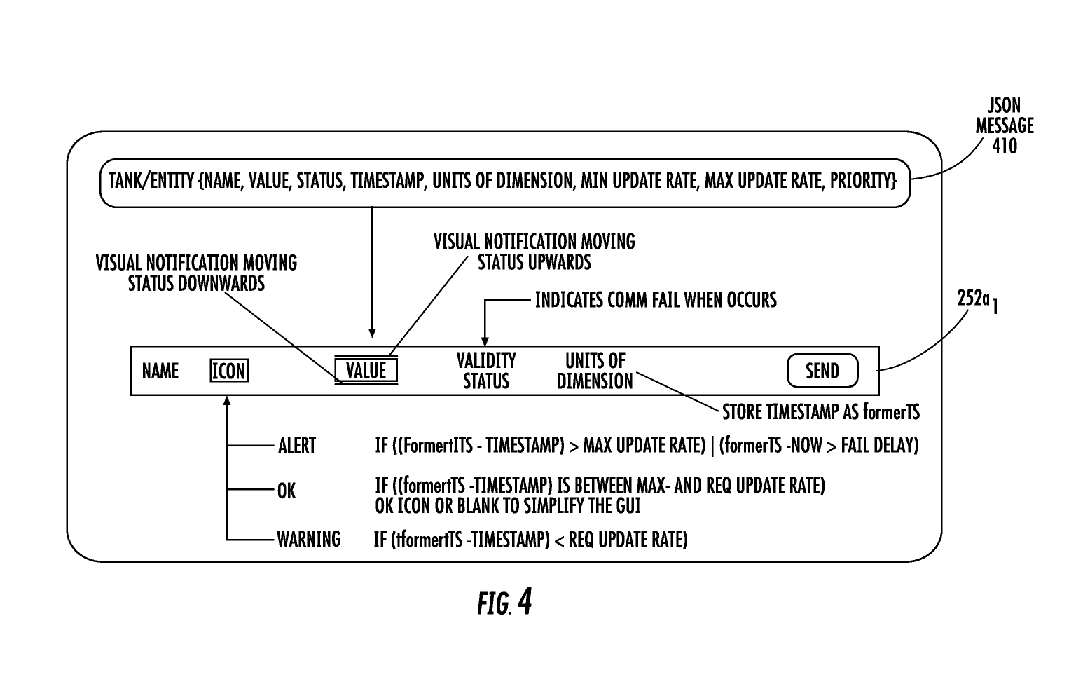

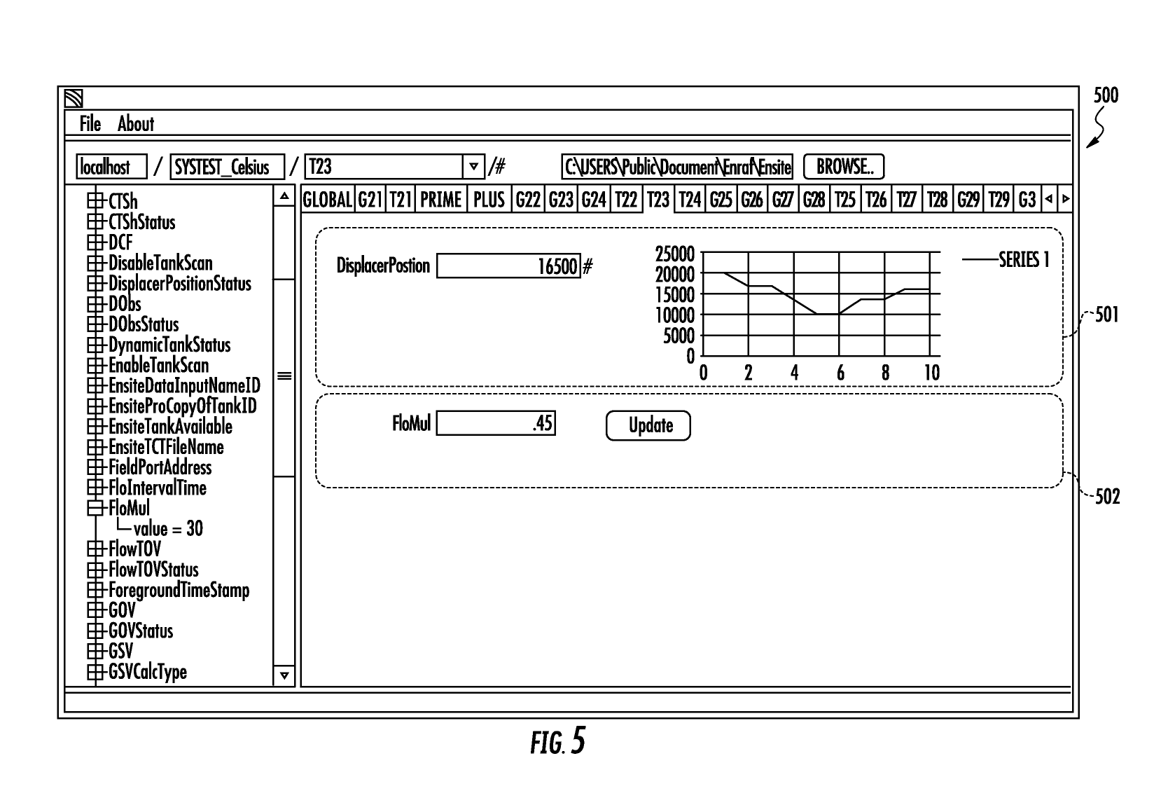

However, configuration updates can be provided by generally any other application hosting instances of the custom GUI control 251, such as a service tool application (not visualized) in the application layer 250 to the IP data provider 135f, as well as other updates of data and/or commands such as kill, manual overwrite and resurrects. The “send” button as visualized in FIG. 4 (described below) will generally be hidden by default. (The send button is shown in FIG. 5 (described below) as an “update”. When the serialized message indicates the value belongs to categories such as configuration or operational data the send button will be shown after the value is modified by the user.

The publisher subscriber pattern of a publisher/subscriber model is used to deliver (push) field data to clients running a GUI application 252, such as a WINDOWS or LINUX GUI applications. Stored messages are organized in the memory 135f₁ of the IP data provider 135f around a tree of topics, and clients that subscribe to messages stored at the memory 135f1 are delivered particular topics or to groups of topics they are subscribed to. The data pushed to the clients is generally used by the client using a GUI application 252 to fill the GUI components 252a2 of the display element 252a₁ for representing field data with both text and graphics to clients such as operators at operator stations generally running at a personal computer (PC) or mobile device.

As known in communications, the IP suite is the computer networking model and set of communications protocols that is used on the Internet and similar computer networks commonly known as TCP/IP based on its most important protocols, the Transmission Control Protocol (TCP) and the IP being the first networking protocols defined during its development. The IP communications can comprise, but is not limited to machine (M2M)/Internet of Things known as MQTT, Advanced Messaging Queuing Protocol (AMQP), and OPC UA. The process data from the plant 105 which may be referred to as a device layer is converted from a serial protocol (e.g., Modbus) to IP communications which pushes the data directly to the GUI application 252 by using a publish subscriber pattern. For example, in collaboration with a MQTT broker, live data from field devices in the plant 105 can be pushed into the GUI application 252 instead of the GUI application layer pulling the data on request or at selected time intervals. The use of a MQTT broker enables the data to get pushed (published) to the GUI application 252.

The custom GUI control 251 in the GUI application 252 is programmed by the initial serialized object/JSON message published by the IP data provider 135f′ over the IP bus 139′ (e.g., TCP/IP bus) to know how to handle all parameters of the received serialized object message. The custom GUI control 251 will serve a variety of standard features by context menus e.g. trending, conversions to other units and verbose information of the data. This arrangement substantially simplifies the creation of GUI applications. By embedding these options in the generic GUI control component all data will be visualized equally and individual implementations are no longer needed. The custom GUI control 251 can be developed in different languages including C#, PHP, ASP.NET, Perl, etc. to serve PC applications, Web applications or native mobile apps in different operating systems including WINDOWS, IOS, LINUX and others.

In operation of the communications, the GUI application 252 subscribes to call-backs from the IP data provider 135f (e.g., IIoT broker) which provides serialized object type (e.g., JSON) messages containing a field with a unique name (e.g. the MQTT topic or OPC item). The topic is the complete branch e.g. “Site1/Tank1/Gauge1/Level” and not just “Level”. The received serialized message received by the GUI application 252 contains the MQTT topic or OPC item. This topic is used to create a referable instance of custom GUI control 251 for the GUI application 252. The remaining fields of the serialized message all get used to populate respective sub-controls (GUI components) in the custom GUI control 251, such as the status, validity, units of dimension, a new value in a trend chart, etc.

For the next (and subsequent) call-back(s), all the GUI application 252 has to obtain is the topic from the serialized object type message (the topic is the Tankl/Level shown below in the example JSON message) received from the IP data provider 135f and pass it on to the custom GUI control 251 which was instantiated (created based on this topic before). The sub-controls (GUI Components) of the custom GUI control 251 are based on the serialized object type message which will atomically update all of the GUI components 252a₂ (e.g., in one example elements are “Category, Dimension, DimensionID, EntityID, MaxUpdateRate, MinUpdateRate, Name, NValue, Priority, Status, Timestamp”) of the display element 252a₁. An example JSON message for tank gauging can comprise: Topic e.g.: “Tank1/Level” and the following JSON message contents:

```
{
  Category,
  Dimension,
  DimensionID,
  EntityID,
  MaxUpdateRate,
  MinUpdateRate,
  Name,
  NValue,
  Priority,
  Status,
  Timestamp,
  etc.
  }
```

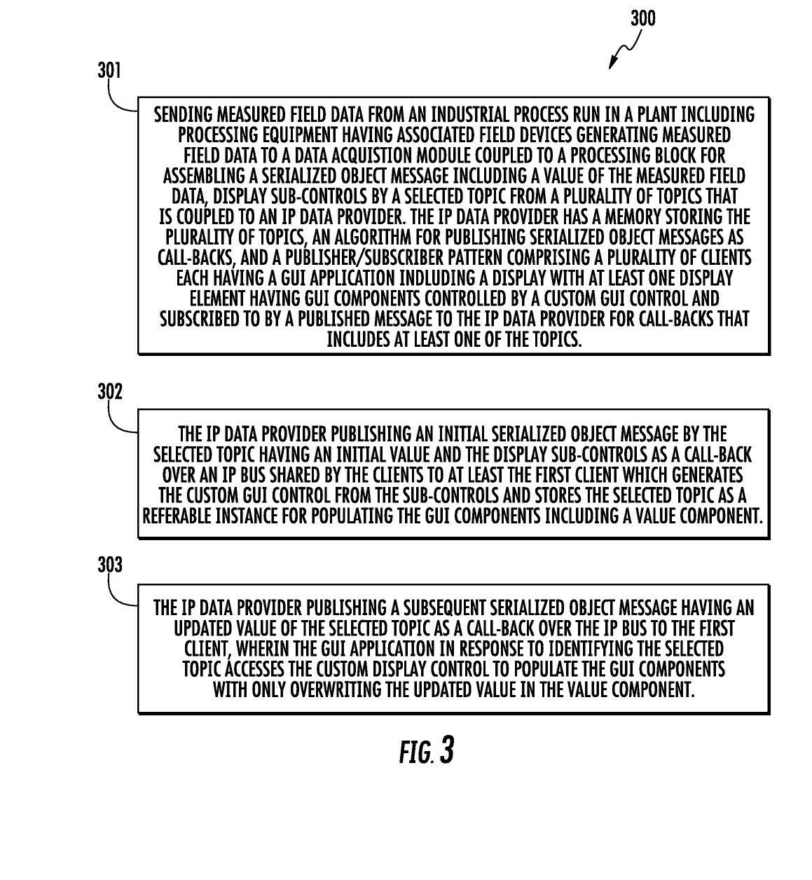

FIG. 3 is a flow chart that shows steps in a method 300 of visualizing of field data for process control in an industrial control system using a custom GUI control that utilizes only one message per value, according to an example embodiment. Step 301 comprises sending measured field data from an industrial process run in a plant including processing equipment having associated field devices generating measured field data to a data acquisition module coupled to a processing block for assembling a serialized object message including a value of the measured field data, display sub-control by a selected topic from a plurality of topics that is coupled to an IP data provider. The IP data provider has a memory storing the plurality of topics, an algorithm for publishing serialized object messages as call-backs, and a publisher/subscriber pattern comprising a plurality of clients each having a GUI application including a display with at least one display element comprising GUI components controlled by a custom GUI control and subscribed to by a published message to the IP data provider for call-backs that includes at least one of the topics.

Step 302 comprises the IP data provider publishing an initial serialized object message by the selected topic as a call-back over an IP bus 139′ shared by the clients to at least the first client which generates the custom GUI control and stores the selected topic as a referable instance for populating the GUI components including a value component. Step 303 comprises the IP data publishing a subsequent serialized object message having an updated value of the selected topic as a call-back over the IP bus to the first client. The GUI application in response to identifying the selected topic accesses the custom display control to populate the GUI components with only overwriting the updated value in the value component.

### EXAMPLES

Disclosed embodiments of the invention are further illustrated by the following specific Examples, which should not be construed as limiting the scope or content of this Disclosure in any way.

The GUI components of an example display element 252a₁ of a WINDOWS PC is controlled by a custom GUI control handler 252c that receives a JSON message 410 are both shown in FIG. 4. The contents of the JSON message 410 received by the GUI application 252 from the IP data provider 135f is used to create the custom GUI control 251 that updates all the GUI components 252a2 of the display element 252a₁ of GUI application 252 at the same time. In FIG. 4 the JSON field “value” goes into the textbox, the JSON field “status” will be shown behind the value by two characters. The JSON message field “dimension” will be presented next to the validity status characters to show the units of dimension of the data. The current “value” is compared with the last received “value” of the data. In the case the current value is changed relative to previously received value of the data, only the value GUI component in the display element can be updated. The custom GUI control 251 can also cause different colored lines to be shown adjacent to the value box, such as a blue line on top or brown line underneath the value box, which can indicate whether the data value is increasing or decreasing. The scan rates are provided by the JSON fields “Min-” and “MaxUpdateRate”.

The rules in FIG. 4 shows that related to the timestamp, last timestamp and “Min-” and “MaxUpdateRate” the custom GUI control 251 will show an Icon to indicate Good, Underrun or overrun of the scan. As noted above, the “send” button shown in FIG. 4 will generally be hidden by default. When the serialized message shown as JSON message 410 indicates the value belongs to categories such as configuration or operational data, the send button will be shown after the value is modified by the user. When more data such as a value from a redundant gauge becomes available in the serialized message in the future, more handling in the GUI control handler 252c and associated GUI components 252a₂ can be added to the display element 252a₁ to show the added content to the user.

FIG. 5 is a scanned picture that shows the workings of a disclosed custom GUI control in a proof of concept (POC) created in an example display 500 that includes a an instance of the custom GUI control as DisplacerPosition display element 501 shown on the top and a second instance as the FloMul display element 502 below the DisplacerPosition display element 501. The display in FIG. 5 is wider than that shown in FIG. 4.

The DisplacerPosition element 501 is shown having the text “DisplacerPosition” with the adjacent textbox containing “16500” for the DisplacerPosition value, the # as status and the trend chart”. The displacer position is a measured value. On demand of the user the trend chart for the DisplacerPosition parameter shown to the top right side in in FIG. 5 becomes visible in the DisplacerPosition element 501 next to the location having the send button shown in FIG. 4. For this the option to show a trend chart is turned ON. The DisplacerPosition element 501 shows the content of the JSON message received by the call-back to the subscription SYSTEST_Celsius/T23 DisplacerPosition. The FloMul element 502 shows the contents of the call-back SYSTEST_Celsius/T23/FloMul showing a current FloMul value. The FloMul value is a configuration and has been changed by the user (when data gets altered the background of the GUI value component can turn a particular color, such as yellow). On this, the button appears which the user can use to create an updated JSON message and send it back to the IP data provider 135f for storage in the configuration database 135e.

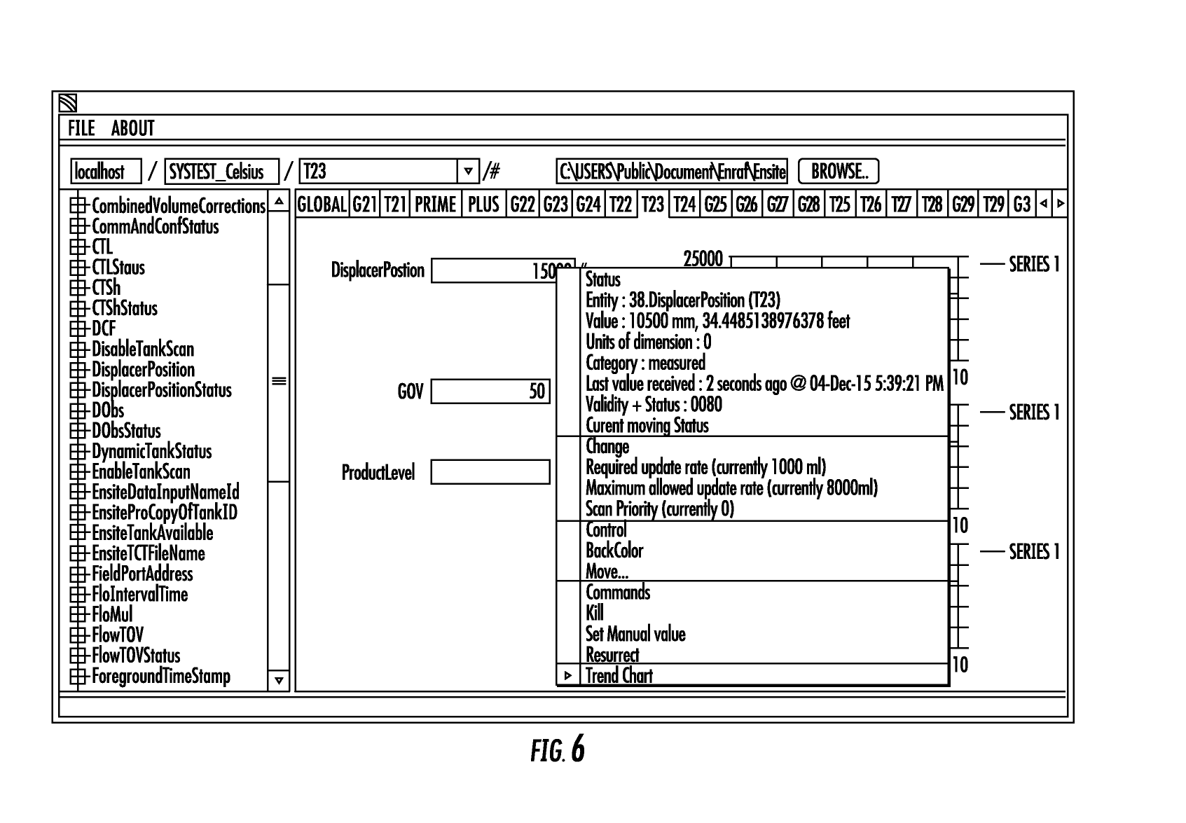

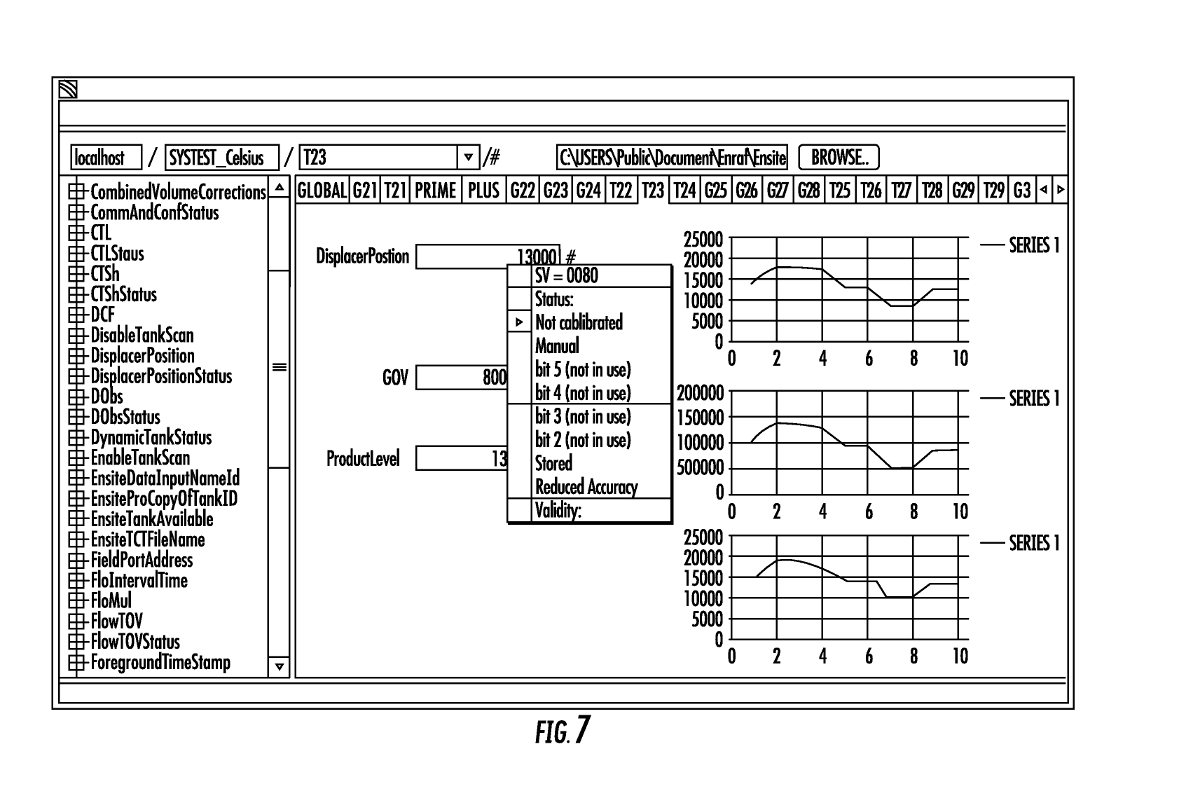

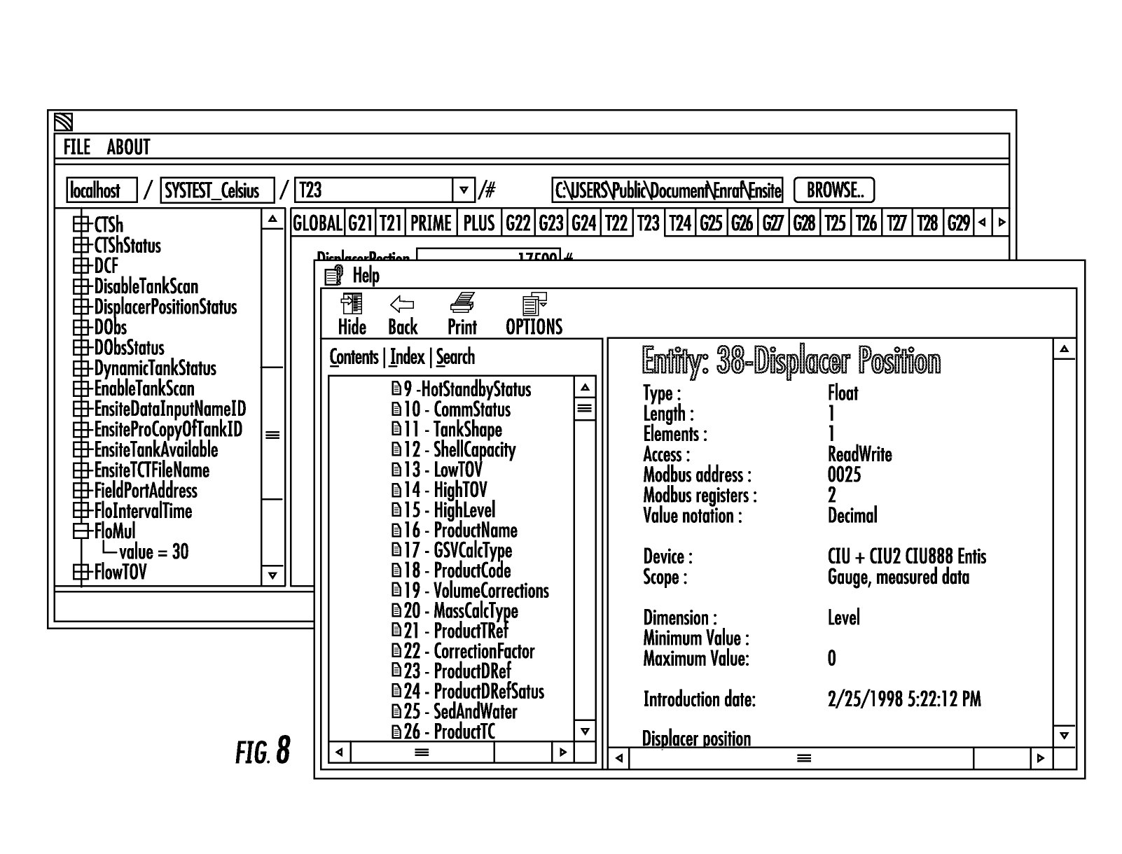

FIG. 6 is a scanned picture that shows the verbose information provided by all JSON fields including live updates shown when the user right clicks on the value textbox. FIG. 7 is a scanned picture that shows verbose information about the status and validity when the user right clicks on the place where the status is shown. FIG. 8 is context sensitive, detailed help about the entity of selected control that shows a hyperlink available to launch help file (e.g. a Microsoft compiled HTML (chm-file)) which shows all details and help for the data displayed by the control.

Regarding the examples above, when more fields get defined for the JSON message in the design new sub-controls can be created to allow filling of new GUI components 252a₂. This enables more data parameters to be shown to the user in the same generic way as described above.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of custom graphical user interface (GUI) control, comprising:
sending measured field data from an industrial process run in a plant including processing equipment having associated field devices generating measured field data to a data acquisition module coupled to a processing block for assembling a serialized object message including a value of said measured field data, display sub-controls by a selected topic from a plurality of topics coupled to an IP data provider, said IP data provider having a memory storing said plurality of topics, an algorithm for publishing said serialized object message as a call-back, and a publisher/subscriber pattern comprising a plurality of clients each having a GUI application including a display with at least one display element having GUI components controlled by a custom GUI control and subscribed to by a published message to said IP data provider for said call-back that includes at least one of said plurality of topics;
said IP data provider publishing an initial serialized object message by said selected topic having an initial value and said display sub-controls as a call-back over an IP bus to at least a first client which generates said custom GUI control from said display sub-controls and stores said selected topic as a referable instance for populating said GUI components including a value component, and
said IP data provider publishing a subsequent said serialized object message having an updated value and said selected topic as a call-back over said IP bus to at least said first client, wherein said GUI application in response to identifying said selected topic accesses said custom GUI control to populate said GUI components with only overwriting said updated value in said value component.

2. The method of claim 1, wherein said serialized object message comprises a JavaScript Object Notation (JSON) message or a Binary JSON message.

3. The method of claim 1, wherein said IP data provider comprises a Message Queuing Telemetry Transport (MQTT) broker.

4. The method of claim 1, wherein said processing equipment includes at least one storage tank, and wherein said measured field data comprises tank gauging data.

5. The method of claim 1, wherein said display sub-controls include attributes for a plurality of said values, timestamp, status, validity, units of dimension, and new ones of said values in a trend chart.

6. The method of claim 1, further comprising one of said plurality of clients publishing a configuration for said serialized object message to said IP data provider.

7. A data processing and visualization system, comprising:
a field layer having a data acquisition module coupled to receive measured field data from an industrial process run in a plant including processing equipment having associated field devices generating measured field data, said data acquisition module coupled to a processing block for assembling a serialized object message by a selected topic from a plurality of topics including a value of said measured field data and display sub-controls coupled to an IP data provider,
said IP data provider having a memory storing said plurality of topics and a publisher/subscriber pattern comprising a plurality of clients in an application layer each having a graphical user interface (GUI) application including a display having at least one display element having GUI components controlled by a custom GUI control and subscribed by a published message to said IP data provider that includes at least one of said plurality of topics to said IP data provider for call-backs;
said memory having an algorithm for:
publishing said call-backs as said serialized object message by said selected topic including said value and said display sub-controls over an IP bus shared by said plurality of clients,
publishing an initial one of said serialized object message by said selected topic having an initial value and said display sub-controls as a call-back to at least a first client, wherein in response said first client generates said custom GUI control from said display sub-controls, and stores said selected topic as a referable instance for populating said GUI components including a value component, and
publishing a subsequent one of said serialized object message having an updated value of said selected topic to at least said first client, wherein said GUI application in response to identifying said selected topic, accesses said custom GUI control to populate said GUI components with only overwriting said updated value in said value component.

8. The data processing and visualization system of claim 7, wherein said serialized object message comprises a JavaScript Object Notation (JSON), or a Binary JSON message.

9. The data processing and visualization system of claim 7, wherein said IP data provider 135f comprises a Message Queuing Telemetry Transport (MQTT) broker.

10. The data processing and visualization system of claim 7, wherein said display sub-controls include attributes for a plurality of said values, timestamp, status, validity, units of dimension, and new ones of said values in a trend chart.

11. The data processing and visualization system of claim 7, further comprising a configuration database coupled between said processing block and said IP data provider for receiving and storing a new configuration from one of said plurality of clients.

12. A computer program product, comprising:
a non-transitory data storage medium that includes program instructions executable by a processor to enable said processor to execute a method of custom graphical user interface (GUI) control, comprising:
code for sending measured field data from an industrial process run in a plant including processing equipment having associated field devices generating measured field data to a data acquisition module coupled to a processing block for assembling a serialized object message including a value of said measured field data, display sub-controls by a selected topic from a plurality of topics coupled to an IP data provider, said IP data provider having a memory storing said plurality of topics, an algorithm for publishing said serialized object message as a call-back, and a publisher/subscriber pattern comprising a plurality of clients each having a GUI application including a display with at least one GUI component controlled by a custom GUI control and subscribed to by a published message to said IP data provider for said call-back that includes at least one of said plurality of topics;
code for said IP data provider publishing an initial serialized object message by said selected topic having an initial value and said display sub-controls as a call-back over an IP bus to at least a first client which generates said custom GUI control from said display sub-controls and stores said selected topic as a referable instance for populating said GUI components including a value component, and
code for said IP data provider publishing a subsequent said serialized object message having an updated value and said selected topic as a call-back over said IP bus to at least said first client, wherein said GUI application in response to identifying said selected topic accesses said custom GUI control to populate said GUI components with only overwriting said updated value in said value component.

13. The computer program product of claim 12, wherein said serialized object message comprises a JavaScript Object Notation (JSON) message or a Binary JSON message.

14. The computer program product of claim 12, wherein said IP data provider comprises a Message Queuing Telemetry Transport (MQTT) broker.

15. The computer program product of claim 12, wherein said display sub-controls include attributes for a plurality of said values, timestamp, status, validity, units of dimension, and new ones of said values in a trend chart.
